(19) United States
(12) Patent Application Publication
(10) Pub. No.: US 2025/0267312 A1
(43) Pub. Date: Aug. 21, 2025

(54) Method for managing access to content having been broadcast in real time

(71) Applicant: ORANGE, Issy-les-Moulineaux (FR)

(72) Inventors: Olivier Gaste, CHATILLON CEDEX (FR); Hervé Marchand, CHATILLON CEDEX (FR)

(21) Appl. No.: 19/054,107

(22) Filed: Feb. 14, 2025

(30) Foreign Application Priority Data
Feb. 20, 2024 (FR) 2401643

(51) Int. Cl. H04N 21/231; H04N 21/266

(52) U.S. Cl. CPC H04N 21/231; H04N 21/266

(57) ABSTRACT

A method for managing the storage of parts of content following successive broadcasts of the parts, wherein the parts that have been broadcast are stored over a given time range preceding the current broadcast time. The time range varies over time.

### CROSS-REFERENCE TO RELATED APPLICATIONS

This Application claims priority to French Patent Application No. FR2401643, filed Feb. 20, 2024, the content of which is incorporated herein by reference in its entirety.

### TECHNICAL FIELD

The field of the present disclosure is that of managing the storage of content that is currently being broadcast with a view to a delayed playback by a playback device.

The playback device is intended for all data processing devices equipped with processors capable of receiving and playing or replaying content broadcast from a content server.

Such a playback device is, for example, a digital television decoder.

The content referred to here is multimedia content. This content is, for example, television content.

### PRIOR ART

When accessing multimedia content, a playback device sends a request to a content server by indicating chosen multimedia content (video and/or audio). The playback device receives in return a stream of digital data relating to this content.

The received data are then decoded by the playback device and reproduced in the form of a display of the corresponding multimedia content.

The content server can transmit content in a variety of ways, such as multicast mode (e.g. IPTV), unicast mode, etc. After receiving the content, the playback device decodes the content and requests reproduction on a reproduction device.

Live streaming of video content in HTTP adaptive streaming (HAS) allows video to be broadcast in OTT mode, offering the best possible quality to the user according to the bandwidth available on the network. This broadcasting is based on an exchange of a description file (also referred to as a “manifest” by a person skilled in the art) between an HAS content broadcast server and a customer playback device. For live streams, this description file describes (in the form of URLs) the latest video segments that have been produced. These segments generally all have the same duration (for example, 2 seconds).

In addition to the playback of content, certain playback devices offer a function known as “start over” by a person skilled in the art (or “catch up” or “replay from the start”) which allows a user, for example when watching content broadcast in real time (channel broadcast live), to play back a part of the content that was broadcast live; this function makes it possible, in particular, to replay content from a desired time, for example from the start. If, for example, a movie broadcast in real time starts at 9:00 pm and the user accesses the corresponding live stream by tuning in to the channel at 9:40 pm, by selecting a command linked to the catch-up function, the user can request that the playback of the content resumes for example from a desired time, for example 9:15 pm, or even from the start of the movie, i.e. 9:00 pm In this case, the user switches from a real-time playback mode to a delayed playback mode.

To allow a user to return to programs broadcast several hours ago, the description files which are transmitted successively must describe audio/video segments of which the production no longer corresponds solely to the live broadcast, but to a more distant time in the past, for example 4 hours ago. This then represents a highly significant increase in the size of the description file changing from a size in the order of 12 KB (description of 30 segments of 2 seconds) for the live broadcast to a size in the order of 2.8 MB (description of 7200 segments of 2 seconds) for 4 hours of description. This increase in the size of the description file requires a significant bandwidth consumption, especially for ADSL users, and also substantial parsing times, which can adversely affect the smooth flow of the graphical interface.

Another problem related to “start over” mode is that, as soon as a part of the content has been broadcast, that part is recorded by the content broadcaster for a given period of time. In this example, the given duration corresponds to a time range preceding the current broadcast time. This time range TR is, for example, four hours for all of the television channels. Due to the constant duration of the time range and the start times of television programs that vary in time from one channel to another, the amount of content that is accessible to a user in this time range is then no longer only the content that is currently being broadcast, but also the content that has finished broadcasting.

Stored content of finished broadcasts therefore takes up memory space unnecessarily. The memory space dedicated to storing content that has been broadcast in real time is therefore not optimally managed. However, the main concern is to enable the delayed playback of content currently being broadcast, in full from the start.

One or more aspects of the present disclosure improves the situation.

### SUMMARY

For this purpose, a first functional aspect relates to a method for managing the storage of parts of content following successive broadcasts of said parts, wherein the parts that have been broadcast are stored over a given time range preceding the current broadcast time, characterized in that the time range varies over time.

According to an aspect of the disclosure, unlike the prior art in which the size of the time range is fixed, the size of the time range dedicated to storing the parts of content that have been broadcast varies over time. As explained below, this variation makes it possible to store only content that meets given criteria.

Since the time range varies, the parts of content stored in memory during the broadcast can be chosen appropriately, for example according to predefined criteria, by means of an aspect of the present disclosure, for the purpose of possible delayed playback. For a given broadcast channel, for example, only the content currently being broadcast is stored. According to another example, relating to a given broadcast channel, only the content currently being broadcast and the last content that has finished broadcasting are stored in memory. An aspect of the present disclosure ensures a playback of content from the start.

In addition, when the variation referred to above is a decrease in the quantity of segments, the resulting description file also decreases in size as there are fewer segments to describe. Finally, successive downloads consequently occupy less bandwidth on the network and the playback of the description file in the playback device takes place more quickly because of the reduced size of the description file.

According to one particular aspect of the disclosure, wherein the time range has a start time, referred to as the first time, and a content has a start time, referred to as the second start time; the first time coincides with the second time. This embodiment avoids storing content that has finished broadcasting. A single content is thus stored in the time range, i.e. the content currently being broadcast. Thus, as soon as content is not accessible in full, it is deleted from the storage space and is no longer described in the description file that is made available. Also, the fact that the times coincide has the advantage that the request for delayed playback from the start leads to delayed playback without waiting.

According to one variant of the preceding embodiment, a time delay is implemented before the delayed playback. This time delay allows, for example, the broadcasting of other content such as advertising content, an image, a video displaying a countdown, before the delayed playback of the content. This time delay also offers convenience for the user by giving him time to get ready to view the content under suitable conditions.

According to another embodiment which can be implemented alternatively or cumulatively with the preceding embodiment, the time range has a start time, referred to as the first time, and a content has a start time, referred to as the second start time, and the first time precedes the second time. In this embodiment, the start time of the time range is such that playback from the start will reproduce the end of the last content that has finished broadcasting; the storage of the end of this content addresses the technical problem in that its reproduction serves, as in the previous mode with the time delay, to offer convenience for the user by giving him time to get ready to view the content under suitable conditions. The delay between the start times is ideally a few seconds, and can be greater depending on how it is used.

In any case, the preceding embodiment and the associated variant guarantee delayed playback of the content in full and, a fortiori, reduce the size of the description file since the latter describes only the segments of the content stored during broadcasting.

According to another embodiment which can be implemented alternatively or cumulatively with the preceding embodiments, a time range has a maximum value, and the start times referred to above coincide until the maximum time range is reached. This mode allows the memory space occupied by a particular content to be limited, particularly if this content has a long duration.

According to another embodiment which can be implemented alternatively or cumulatively with the preceding embodiments, content is broadcast on a plurality of different broadcast channels. In this case, the sum of the time ranges associated with some or all of the broadcast channels is less than a given value. This embodiment complements the previous embodiment by limiting the total storage associated with all of the broadcast channels.

According to a first hardware aspect, the disclosure relates to an entity for managing the storage of parts of content after successive broadcasts of said parts, the storage of the parts which have been broadcast being carried out over a given time range preceding the current broadcast time, characterized in that the entity comprises a processor configured to make the time range variable over time.

According to another hardware aspect, the disclosure relates to a playback device comprising a management entity as defined above.

According to another hardware aspect, the subject-matter of the disclosure relates to a computer program capable of being implemented on a management entity as defined above, the program comprising code instructions which, when it is executed by a processor, carries out the steps of the management method defined above.

According to another hardware aspect, the subject-matter of the disclosure relates to a data medium on which at least one set of program code instructions for executing a management method as defined above has been stored.

The medium referred to above can be any entity or device capable of storing the program. A medium can comprise, for example, a storage means, such as a ROM (read-only memory), for example a CD ROM or a microelectronic circuit ROM, or a magnetic recording means, for example a hard disk. On the other hand, an information medium can be a transmissible medium such as an electrical or optical signal, which can be routed via an electrical or optical cable, by radio or by other means. The program according to an aspect of the present disclosure can, in particular, be downloaded over a network such as the Internet. Alternatively, the information medium can be an integrated circuit into which the program is incorporated, the circuit being suitable for carrying out or for being used to carry out the method concerned.

The various aspects of the present disclosure will be better understood from a reading of the description which follows, given only by way of example, and with reference to the drawings, in which:

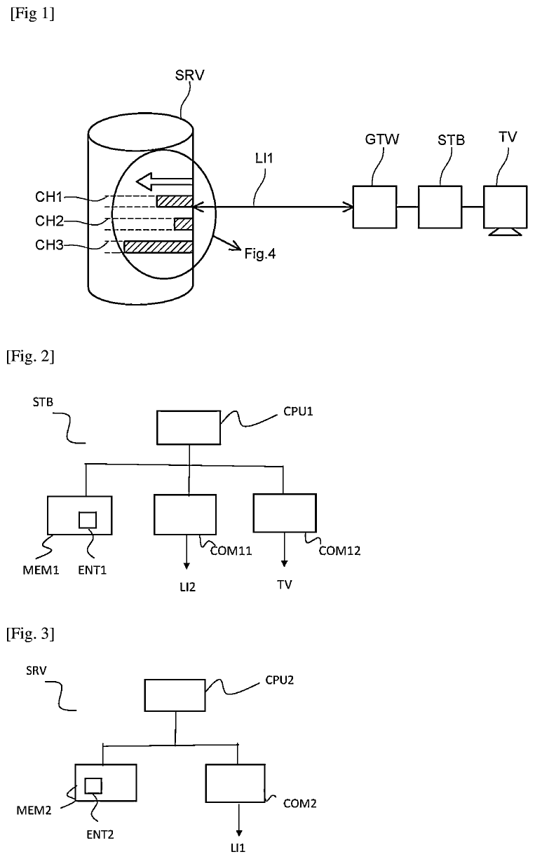

FIG 1 shows a computer system in which an aspect of the present disclosure can be implemented;

FIG. 2 shows schematically the hardware structure of a server capable of transmitting description files;

FIG. 3 shows schematically the hardware structure of a playback device capable of playing multimedia streams in real time;

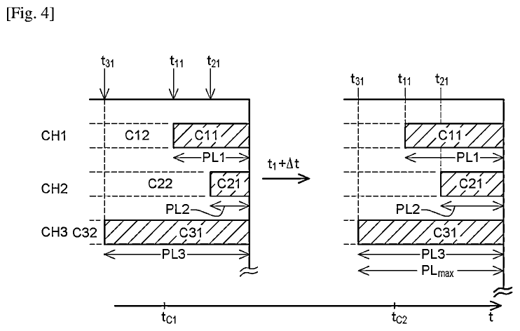

FIG. 4 shows an embodiment of the method according to an aspect of the present disclosure. This figure is a magnification of a part of FIG. 1 showing the management of the content storage in the memory of the server during the respective broadcasts of this content; the entity manages the storage of the content following its broadcasting in order to allow a delayed playback of the content; this figure shows two storage states at two different times in order to highlight the respective variability of the time ranges associated with the broadcast channels as a function of time.

### DETAILED DESCRIPTION OF ILLUSTRATIVE ASPECTS OF THE DISCLOSURE

FIG. 1 shows a computer system SYS in which a content distribution network referred to as a CDN by a person skilled in the art is implemented, from which content is transmitted to customer devices or devices for playback of content and the description files associated with the multimedia content. The content broadcast server, referred to herein as the content server, broadcasts on a plurality of broadcast channels associated with television channels.

In this example, for the sake of simplifying the description, the system SYS comprises a single playback device STB. However, the disclosure applies to any number of playback devices, an exemplary principle of the disclosure being implementable on some or all of the playback devices STB.

The playback device is, for example, a digital playback device such as a decoder.

The multimedia content referred to here is video content from a television channel. This content is broadcast from a server that broadcasts television programs live, i.e. in real time.

In this example, the playback device STB is connected to a reproduction terminal TV such as a television. The device can transmit data to be reproduced on the reproduction device TV.

In this example, the playback device STB is connected to a port of the reproduction device TV; the playback device STB and the reproduction device TV could also form one single device.

In this example, the playback device STB is located in a local area network (LAN) managed by a home gateway GTW.

The gateway GTW is capable of communicating via a communication link LI1 which can be a telecommunication network such as a wide area network WAN known to a person skilled in the art.

In this example, the computer system SYS implements a content distribution network, referred to as a CDN to a person skilled in the art, from which content is transmitted to content playback devices STB.

The CDN consists of servers networked in the wide area network; these servers interwork in order to make multimedia content available to users. In order to simplify the description of the disclosure, a single content server SRV will be shown in FIG. 1 to represent the CDN. In this example, the content server SRV is located in the wide area network WAN.

The content server SRV receives, for example, channels of digital television content originating from a broadcast television network (not shown), and makes them available in real time to customer terminals, in this case the playback device STB, via broadcast channels.

FIG. 2 shows an architecture of a playback device STB. This device STB conventionally comprises memories MEM 1 associated with a processor CPU 1. The memories can be ROM (read-only memory) or RAM (random access memory) or flash memories.

The playback device STB can transmit content to be reproduced on the reproduction device TV via a communication module COM12. This module COM12 is, for example, an HDMI link.

The playback device STB communicates with the gateway via an Ethernet module for wired local communication or via a Wi-Fi radio module for wireless local communication with the residential gateway GTW. The module concerned is denoted CMO11 in FIG. 2.

In this example, the playback device STB comprises a downloading module for downloading in HAS (http adaptive streaming) mode (not shown), capable of managing the downloading of content segments if the content is transmitted over the network LI1 in the form of segments in accordance with the adaptive streaming technology known to a person skilled in the art.

It should be noted here briefly that when a user accesses a live stream broadcast in http adaptive streaming (HAS), the playback device STB receives, at regular intervals, generally every two seconds, successively description files, hereinafter referred to as real-time description files, each one generally describing the last sixty seconds of the stream (30 segments of 2 seconds) by supplying URL addresses of segments corresponding to these last sixty seconds. By means of the received segment addresses, the playback device STB can download the segments and replay them one after the other.

With reference to FIG. 3, the server SRV is also equipped with at least one processor CPU2 and memories MEM2 for carrying out computer processing. The server is also equipped with a management entity ENT which forms the subject-matter of the disclosure, the function of which will be described below.

The server SRV communicates with the gateway GTW via the WAN network. The server comprises a communication module denoted COM2 for communication with the WAN network.

Sometimes the start of a television program (film, series, etc.) broadcast in real time is missed, or there is a desire to replay content from a given time. A function referred to as “replay from the start” or “catch up” (also referred to as “start over” or “restart” by a person skilled in the art) makes it possible, at any time, to resume the program currently being broadcast at a time before the current time; for example, the playback of the content can be resumed from its start, or from a time chosen by a user. If a movie starts at 9:00 pm, for example, and the user tunes in to the channel at 9:40 pm, he can request that the content playback resumes from the start of the movie. This then involves switching from a real-time content playback mode to a delayed content playback mode.

In order to access content in delayed playback, the server SRV stores the content parts that have been broadcast. In this example, as shown above, the parts are content segments. The segments that have been broadcast are recorded in the memory MEM 2 just after their respective broadcasts.

These content parts are stored for a certain amount of time. Description files are created accordingly and include not only the addresses of the last segments produced but also the addresses of the stored segments; these files are then made available to the playback device STB to allow access to the segments by downloading them using the URL addresses included in these files.

It should be noted that the segments that have been broadcast are stored over a time range preceding the current broadcast time.

According to an aspect of the present disclosure, a management entity ENT manages the time ranges PTn associated with different broadcast channels CHn by varying the time ranges over time. In this example, the entity manages the time ranges so as to store only the content currently being broadcast on the different broadcast channels respectively. Description files are created accordingly.

Finally, the time ranges can differ from one channel to another.

FIG. 4 described below provides a schematic view of possible embodiments.

FIG. 1 shows schematically, in the server SRV, a list of content originating from broadcast channels of respective television channels CH1-CH3; FIG. 5 shows an enlarged schematic view of a part of FIG. 1; this part shows schematically the state of occupancy of the memory in connection with each of the three respective broadcast channels CH1/CH2/CH3. A time axis is shown to define the broadcast direction.

Time ranges PTn (n corresponds to a channel CHn, where n is an integer) are also shown in connection with each broadcast channel. The time ranges precede the current time tc1 (or tc2) of broadcasting by a certain duration. As explained above, this range is managed by the entity ENT which ensures that the chosen duration is such that the channels store only the content that is currently being broadcast. Note that this is only one embodiment; other embodiments can be imagined in which a variation of the time range is implemented.

This FIG. 4 shows changes over time in the storage of the content as the respective content is broadcast.

More precisely, FIG. 4 comprises a state of storage of the content at a first time tc1 and a state of storage of the content at a later time tc2.

At the first given current time, denoted tc1, referred to as the current time, the channels are currently broadcasting content C11, C21, C31 respectively in real time:
first content C11, which started broadcasting at time t11;
second content C21, which started broadcasting at time t21;
third content C31, which started broadcasting at time t31.

At this stage, if a user accesses the channel CH2, the playback device STB receives and reproduces the content broadcast in real time on this channel, i.e. the content C21, for example a soccer match.

Prior to the reproduction of the content broadcast in real time C11, C21 and C31, the same channels CH1, CH2 and CH3 broadcast content successively, i.e.:
channel CH1 broadcast the content C12 and ended the broadcast at time t12; channel CH1 then broadcast the content C11 from time t11, which corresponds to time t12 in this example (a case where t11 and t12 do not correspond is, for example, where advertisements are inserted between the two contents C11 and C12), and continues broadcasting this content at the current time tc1,
channel CH2 broadcast the content C22 and ended the broadcast at time t21; channel CH1 then broadcast the content C21 from time t21 and continues broadcasting this content at the current time tc1,
channel CH3 has been broadcasting content C23 for a time period greater than a maximum time range defined above.

According to one embodiment, considering that the time range PTn has a start time and an end time, the management entity ENT causes the start time denoted ti (where i is an integer designating the i-th channel) of the time range concerned to coincide with the start time of the content currently being broadcast.

According to one variant, a slight delay can be provided between these two times. This delay can, for example, enable the broadcaster to insert content before the reproduction of the stored content; this content is, for example, advertising content, an image, etc.

Using the example above, for each time range, the start time of the first time range associated with the first channel CH1 coincides with the start time t11 of the content C11 currently being broadcast on this first channel CH1.

In FIG. 4, at the current time tc1,
for channel CH1, the time range PT1 extends from the current time tc to t11, the start of the content C1;
for channel CH2, the time range extends from the current time tc to t21, the start of the content C2;
for channel CH3, the time range PT3 extends from the current time tc to time t31, the start of the content C3.

In FIG. 4, the frames with solid lines and hatching indicate the content parts that are stored in memory and are therefore accessible for delayed playback; the frames with dashed lines indicate the content parts that are not stored in memory and are not therefore accessible for delayed playback.

FIG. 4 also shows a state of the content stored at another later time tc2:
between t1 and t2, the server continued broadcasting the content C11/C21/C31. It is assumed that the same content is currently being broadcast. Since, in the chosen embodiment, the start time of a time range tn (where n is an integer designating the nth channel) coincides with the start time tn1 of the content currently being broadcast, the different time ranges PTn have increased by a time period corresponding to the subtraction of the two time periods t1 and t2 (t2−t1).

On the right-hand side of FIG. 4, the time ranges can be seen to vary over time such that only the content currently being broadcast is available for delayed playback.

Let it be assumed that a user wishes to play back the content C21 in delayed mode.

This user selects the second channel CH2, and the content currently being broadcast is received by the playback device STB which reproduces the content C21.

When the user wishes to play back this content C21 in delayed mode, an interface is displayed, for example, on the reproduction device TV in the form of a banner at the bottom of the screen, for example after the user has tuned in to a television channel. When the user selects a channel with his remote control, for example, a banner including information and commands relating to the playback mode is displayed each time a channel is accessed. This display allows a user accessing the television program to request delayed playback of stored content.

In this example, the interface reproduces the commands accessible from the banner, i.e. the rewind command known by the “<<” symbol, a replay from the start command (represented by a symbol in the form of a circle with a counter-clockwise arrow) to replay content from the start.

A “return to live” command is sometimes also provided, which, when a delayed playback is in progress, allows a return to the live stream with continued playing of the live broadcast content. Nevertheless, in the present text, this command is not shown as it is irrelevant to the present disclosure.

The controls are accessible from a control interface such as a remote control. The rewind or replay from the start commands, when executed by the processor CPU1 of the playback device STB, cause a delayed playback of the live content currently being broadcast.

On the interface, the user selects the replay from the start command.

At this time, the management entity ENT requests access to the content C21 from the start.

Following receipt of the access request, the server SRV transmits a description file including the URLs of the segments that correspond to the start time of the time range t21 which corresponds to the start time t21 of the second content C21.

The playback device STB accesses the segments of the content by means of the URLs included in the description file.

With the embodiment described above, a replay from start command causes a replay from the start of the content currently being broadcast.

The disclosure is not limited to this example. The start time of the time range could coincide with the start time of the last content that has been broadcast and has finished broadcasting. Other possible variants can be imagined. In all cases, the time range varies in the sense that it increases or decreases. This principle can be applied to a subset of channels, the operation on the other channels functioning as in the prior art.

The time range cannot increase indefinitely. According to one possible variant, the time range has a maximum value PLmax. In this case, the start times coincide until the maximum time range is reached. Beyond that, the time range retains a constant duration corresponding to the maximum time range PLmax. With this variant, not only the memory space occupied by a content, particularly when this content has a lengthy duration, but also the size of the description files describing the segments stored accordingly can be limited.

According to another embodiment which can be implemented alternatively or cumulatively with the preceding embodiment, the sum of the time ranges associated with some or all of the broadcast channels is less than a given value. Considering, for example, the three channels described with reference to FIG. 4, the sum of the sizes in bytes of the time ranges must be less than a given size in bytes. This embodiment limits the memory space that is occupied in the server SRV.

The sum of the time ranges can also concern only some of the channels, for example channels CH1 and CH3.

When the sum of the time ranges reaches a maximum value, the management entity ENT is unable, for example, to store any more content in memory until the sum of the time ranges decreases below the defined maximum value.

According to a final embodiment, usable in isolation or in combination with a previous embodiment, wherein the time range has a start time, referred to as the first time, and a content has a start time, referred to as the second start time, the first time precedes the second time. Ideally, the first time precedes the second time by a few seconds. This delay allows a user, for example, to settle down in front of his screen.

Finally, it should be noted here too that the term “entity” can correspond to a software component as well as a hardware component or a set of hardware and software components, wherein a software component itself corresponds to one or more computer programs or subprograms or, more generally, to any element of a program capable of implementing a function or a set of functions as described for the modules concerned. Similarly, a hardware component corresponds to any element of a hardware assembly capable of implementing a function or set of functions for the module concerned (integrated circuit, chip card, memory card, etc.).

Although the present disclosure has been described with reference to one or more examples, workers skilled in the art will recognize that changes may be made in form and detail without departing from the scope of the disclosure and/or the appended claims.

1. A management method implemented by a management entity device and comprising:
managing storage of parts of content following successive broadcasts of said parts, wherein the parts that have been broadcast are stored over a given time range preceding a current broadcast time, wherein the time range varies over time.

2. The management method according to claim 1, wherein the time range has a start time, referred to as a first time, and the content has a start time, referred to as a second start time, and the first start time coincides with the second start time.

3. The management method according to claim 2, comprising executing a time delay before a delayed playback of the stored content.

4. The management method according to claim 1, wherein the time range has a start time, referred to as a first time, and the content has a start time, referred to as a second start time, and the start first time precedes the second start time.

5. The management method according to claim 1, wherein the content is broadcast on a plurality of different broadcast channels, and a sum of the time ranges associated with some or all of the channels is less than a given value.

6. A management entity comprising:
at least one processor; and
at least one non-transitory computer readable medium comprising instructions stored thereon which when executed by the at least one processor configure the management entity to manage storage of parts of content after successive broadcasts of said parts, wherein the parts that have been broadcast are stored over a given time range preceding a current broadcast time, and to make the time range variable over time.

7. A server comprising the management entity according to claim 6.

8. A non-transitory computer readable data medium on which at least one set of program code instructions have been stored to carry out a method when the instructions are executed by at least one processor of a management entity, wherein the method comprises:
managing storage of parts of content following successive broadcasts of said parts, wherein the parts that have been broadcast are stored over a given time range preceding a current broadcast time, wherein the time range varies over time.
